(19) United States
(12) Patent Application Publication
(10) Pub. No.: US 2016/0316082 A1
(43) Pub. Date: Oct. 27, 2016

(54) IMAGE FORMING APPARATUS AND INFORMATION PROCESSING APPARATUS

(71) Applicant: Oki Data Corporation, Tokyo (JP)

(72) Inventor: Miwako ISHII, Tokyo (JP)

(21) Appl. No.: 15/069,640

(22) Filed: Mar. 14, 2016

(30) Foreign Application Priority Data
Apr. 27, 2015 (JP) 2015-090007

(51) Int. Cl. H04N 1/00; G06F 3/12

(52) U.S. Cl. CPC H04N 1/00477; H04N 1/00411; G06F 3/121; G06F 3/1229; H04N 1/00015; H04N 1/00034; H04N 1/00068; H04N 1/00076; H04N 2201/0094

(57) ABSTRACT

An image forming apparatus includes a receiving unit, an image forming unit, a detecting unit, a first calculating unit, a second calculating unit and display unit. The receiving unit receives image data sequentially. The detecting unit detects a residual amount of a consumable used for forming the page image by the image forming unit. The first calculating unit calculates a consumption of the consumable based on the image data received by a time point by the receiving unit whenever a prescribed condition is satisfied. The second calculating unit calculates a count of page images that can be formed on at least one sheet based on the consumption and the residual amount whenever the prescribed condition is satisfied. The display unit displays the count of page images calculated by the second calculating unit whenever the prescribed condition is satisfied.

### CROSS REFERENCE TO RELATED APPLICATIONS

This application claims priority under 35 USC 119 to Japanese Patent Application No. 2015-090007 filed on Apr. 27, 2015, the entire contents which are incorporated herein by reference.

### BACKGROUND OF THE INVENTION

1. Field of the Invention

This application relates to an image forming apparatus and an information processing apparatus.

2. Description of Related Art

A conventional image forming apparatus estimates a consumption of a consumable (see, for example, Japanese Laid-open Patent Publication No. 2003-341032).

However, when the conventional image forming apparatus takes significant amount of time for the estimate, a user does not timely learn about deficiency in the amount of consumable available. Therefore, a convenience of the user is low.

### SUMMARY OF THE INVENTION

According to an aspect of the disclosed embodiment, an image forming apparatus includes a receiving unit, an image forming unit, a detecting unit, a first calculating unit, a second calculating unit and display unit. The receiving unit receives image data sequentially. The image forming unit forms at least one page image on at least one sheet based on the image data. The detecting unit detects a residual amount of a consumable used for forming the page image by the image forming unit. The first calculating unit calculates a consumption of the consumable based on the image data received by a time point by the receiving unit whenever a prescribed condition is satisfied. The second calculating unit calculates a count of page images that can be formed on the at least one sheet based on the consumption and the residual amount whenever the prescribed condition is satisfied. The display unit displays the count of page images calculated by the second calculating unit whenever the prescribed condition is satisfied.

According to another aspect of the disclosed embodiment, The information processing apparatus includes a receiving unit, a detecting unit, a first calculating unit, a second calculating unit and an output unit. The receiving unit receives image data sequentially. The detecting unit detects a residual amount of a consumable used for forming a page image. The first calculating unit calculates a consumption of the consumable based on the image data received by a time point by the receiving unit whenever a prescribed condition is satisfied. The second calculating unit calculates a count of page images that can be formed on at least one sheet based on the consumption and the residual amount whenever the prescribed condition is satisfied. The output unit that outputs the count of page images calculated by the second calculating unit whenever the prescribed condition is satisfied.

According to this embodiment, the convenience of the user can be improved.

### BRIEF DESCRIPTION OF THE DRAWINGS

In the attached drawings:

FIG. 1 is a block diagram showing a function configuration of an image forming apparatus;

FIG. 2 is a flowchart showing processing executed by the image forming apparatus;

FIG. 3A is a schematic view showing an operation panel;

FIG. 3B is a schematic view showing the operation panel;

FIG. 3C is a schematic view showing the operation panel;

FIG. 3D is a schematic view showing the operation panel;

FIG. 3E is a schematic view showing the operation panel;

FIG. 3F is a schematic view showing the operation panel;

FIG. 4 is a schematic view showing a method of calculating a count of pages of the image that can be formed on the sheet;

FIG. 5 is a flowchart showing modification of processing executed by the image forming apparatus;

FIG. 6 is a schematic view showing an operation panel;

FIG. 7 is a schematic view showing an operation panel;

FIG. 8 is a schematic view showing an operation panel;

FIG. 9 is a block diagram showing a hardware configuration of an image forming apparatus; and

FIG. 10 is schematic view showing page images and at least one sheet.

### DETAILED DESCRIPTION OF EMBODIMENTS

Hereinafter, preferred embodiments of the invention will be described with reference to the attached drawings.

### 1. Structure

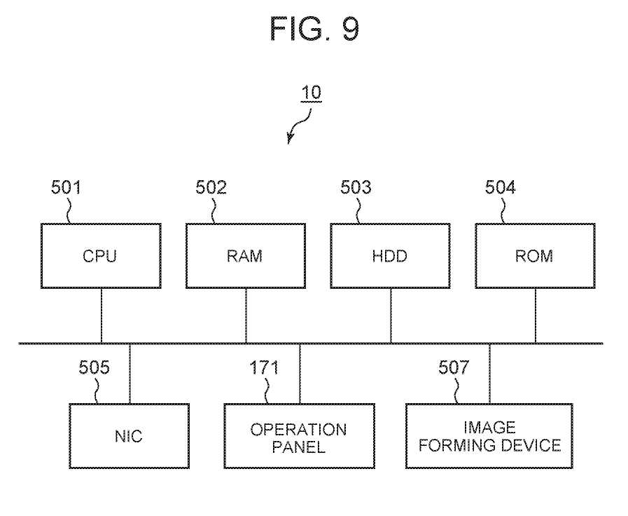

FIG. 9 is a block diagram showing a hardware configuration of an image forming apparatus 10.

As shown in FIG. 9, the image forming apparatus 10 may include a CPU (Central Processing Unit) 501, a RAM (Random Access Memory) 502, a HDD (Hard Disk Drive) 503, a ROM (Read Only Memory) 504, a NIC (Network Interface Card) 505, an operation panel 171, and an image forming device 507.

The CPU 501 controls the entire image forming apparatus 10. The RAM 502 is a readable and writable volatile memory. The HDD 503 is a readable and writable non-volatile memory. The ROM 504 is a read only non-volatile memory. The ROM 504 stores a program and data for controlling the image forming apparatus 10. The NIC 505 transmits and receives data through a network 12 by using a known communication technology. The operation panel 171 may include a touch panel. The operation panel 171 displays screens. The operation panel 171 receives input signals based on a user input to the screens. The image forming device 507 forms at least one page image on at least one sheet such as a paper by using a known printing technology.

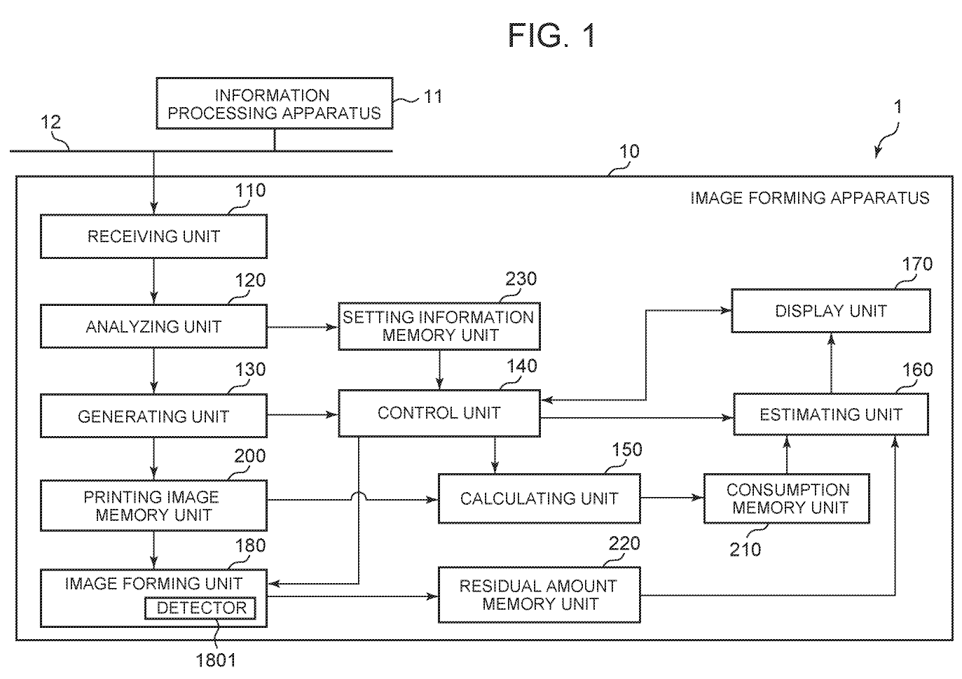

FIG. 1 is a block diagram showing a function configuration of an image forming apparatus 10.

As shown in FIG. 1, the image forming system 1 includes the image forming apparatus 10 and an information processing apparatus 11 such as a PC (Personal Computer).

The image forming apparatus 10 forms at least one page image on at least one sheet by using a consumable such as a developer. The image forming apparatus 10 is connected to the information processing apparatus 11 through the network 12. A printer driver is installed in the information processing apparatus 11. The information processing apparatus 11 generates a printing job. The information processing apparatus 11 transmits the printing job to the image forming apparatus 10 through the network 12. The printing job may include setting information and PDL data (Page Description Language). The setting information indicates a printing condition.

The image forming apparatus 10 may be a color printer or a monochrome printer. The image forming apparatus 10 receives the print job from the information processing apparatus 11. The image forming apparatus 10 forms at least one page image on at least one sheet by using a toner as a developer based on the print job. The sheet may be a continuous paper or a precut paper. In this embodiment, the image forming apparatus 10 is explained as the color printer. The image forming apparatus 10 includes four consumables, namely, a Cyan toner, a Magenta toner, a Yellow toner, and a Black toner. The sheet is explained as the continuous paper. However, they are not limited.

The image forming apparatus 10 may include a receiving unit 110, an analyzing unit 120, a generating unit 130, a printing image memory unit 200, an image forming unit 180, a setting information memory unit 230, a control unit 140, a calculating unit 150, a residual amount memory unit 220, a display unit 170, an estimating unit 160, and a consumption memory unit 210.

The receiving unit 110 receives the print job from the information processing apparatus 11 through the network 12. The receiving unit 110 outputs the print job to the analyzing unit 120.

The analyzing unit 120 analyzes the print job. The analyzing unit 120 writes the setting information included in the print job in the setting information memory unit 230. The analyzing unit 120 outputs the PDL data included in the print job to the generating unit 130.

The generating unit 130 generates printing image data. The printing image data corresponds to a plurality of page images. Whenever the generating unit 130 generates a part of printing image data corresponding to one page image (a page image data set) completely, the generating unit 130 writes the page image data set to the printing image memory unit 200 and outputs a completion notice to the control unit 140.

In other words, the printing image memory unit 200 receives the page image data set from the generating unit 130.

The control unit 140 commands the calculating unit 150 to calculate a required consumption of the toner based on the setting information stored in the setting information memory unit 230. The control unit 140 commands the estimating unit 160 to estimate a count of page images that can be formed on at least one sheet based on the setting information. The control unit 140 commands the image forming unit 180 to form at least one page image on at least one sheet based on the printing image data stored in the printing image memory unit 200.

The calculating unit 150 calculates the required consumption of the toner based on the printing image data stored in the printing image memory unit 200. The calculating unit 150 writes the required consumption of the toner in the consumption memory unit 210. The required consumption of the toner may be calculated based on a pixel number of the printing image data.

The estimating unit 160 calculates the count of page images that can be formed on the sheet based on the required consumption stored in the consumption memory unit 210 and a residual amount stored in the residual amount memory unit 220. The estimating unit 160 compares the required consumption with the residual amount. Then the estimating unit 160 estimates the count of page images that can be formed on the sheet. The estimating unit 160 commands the display unit 170 to display the estimating result.

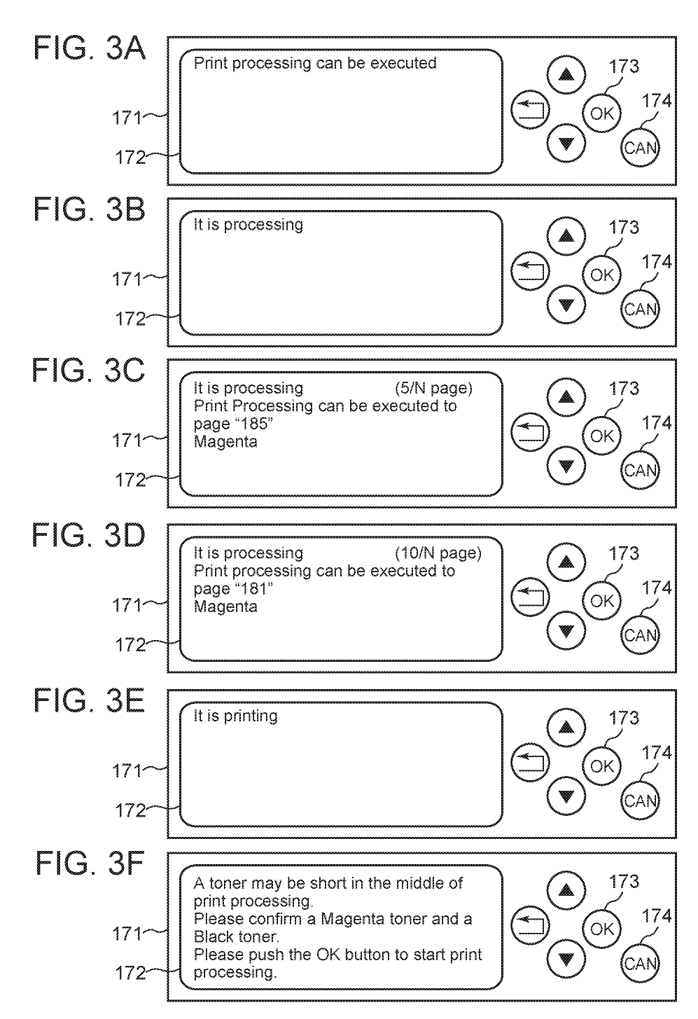

The display unit 170 displays various information. The display unit 170 includes the operation panel 171. The display unit 170 displays the estimating result. The display unit 170 receives input signals based on the user input to the operation panel 171. The display unit 170 outputs the input signals to the control unit 140. As shown in FIG. 3A, the operation panel 171 includes a LCD (Liquid Crystal Display) 172 displaying a message, an OK button 173, and a Cancel button 174.

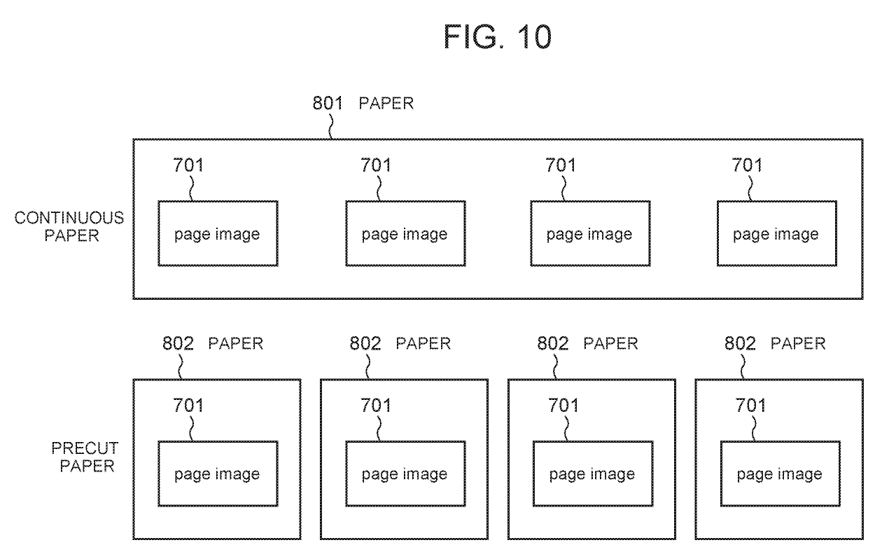

The image forming unit 180 forms at least one page image on at least one sheet. The image forming unit 180 detects the residual amounts of the toners. Specifically, the image forming unit 180 detects the residual amount of the Cyan toner, the residual amount of the Magenta toner, the residual amount of the Yellow toner, and the residual amount of the Black toner. The image forming unit 180 writes the residual amounts to the residual amount memory unit 220. The image forming unit 180 reads the printing image data from the printing image memory unit 200 based on an instruction from the control unit 140. Then the image forming unit 180 forms the at least one page image on the at least one sheet based on the printing image data. Generally, as shown in FIG. 10, the one page image 701 is formed on one sheet (for example, a precut paper 802). However, when the sheet is the continuous paper 801, a plurality of the page images 701 is formed on one sheet.

After the image forming unit 180 forms at least one page image on the at least one sheet, the image forming unit 180 calculates the used consumptions of the toners that were already used by using a known technology. The image forming unit 180 updates the residual amounts stored in the residual amount memory unit 220 based on the used consumptions of the toners that were already used. The image forming unit 180 may include a detector 1801 that detects the residual amounts of the toners.

Whenever a prescribed condition is satisfied, the image forming apparatus 10 calculates the count of page images that can be formed on the at least one sheet based on the required consumption calculated by the calculating unit 150 and the residual amount stored in the residual amount memory unit 220. Then whenever the prescribed condition is satisfied, the display unit 170 displays the count of page images that can be formed on the at least one sheet.

Here, correspondence of the hardware configuration shown in FIG. 9 and the functional configuration shown in FIG. 1 is explained.

The displaying unit 170 can be realized by the CPU 501 and the operation panel 171. The receiving unit 110 can be realized by the CPU 501 and the NIC 505.

The analyzing unit 120, the generating unit 130, the control unit 140, the calculating unit 150 and the estimating unit 160 can be realized by the CPU 501, the RAM 502 and a program stored in the ROM 504 or the HDD 503. Specifically, the analyzing unit 120, the generating unit 130, the control unit 140, the calculating unit 150 and the estimating unit 160 can be realized by the CPU 501 reading out the program stored in the ROM 504 or the HDD 503 to the RAM 502.

However, it is not limited to this example. For example, all or a part of the function of the generating unit 130, the control unit 140, the calculating unit 150 and the estimating unit 160 may be realized by an IC (Integrated Circuit) such as an ASIC (Application Specific Integrated Circuit), FPGA (Field Programmable Gate Array), and so on. Likewise, all or the part of the function of the generating unit 130, the control unit 140, the calculating unit 150 and the estimating unit 160 may be realized by DSP (Digital Signal Processor) and so on.

The printing image memory unit 200, the setting information memory unit 230, the residual amount memory unit 220 and the consumption memory unit 210 can be realized by the CPU 501 and the RAM 502 or the HDD 503.

The image forming unit 180 can be realized by the CPU 501 and image forming device 507.

### 2. Processing

Next, processing executed by the image forming apparatus 10 is explained.

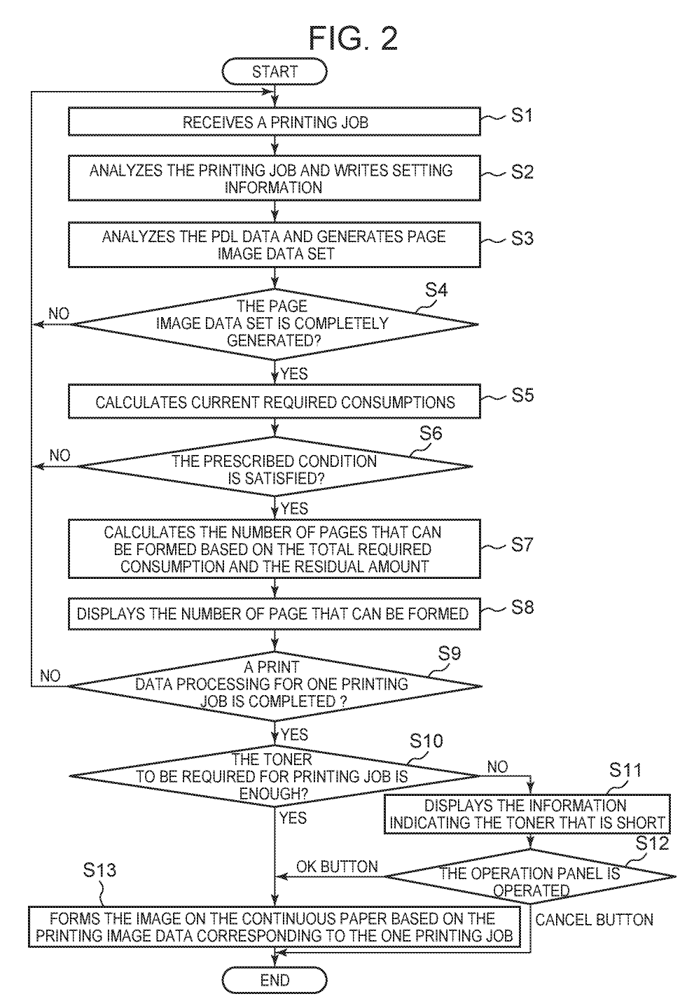

FIG. 2 is a flowchart showing processing executed by the image forming apparatus 10.

As shown in FIG. 2, the receiving unit 110 receives the printing job from the information processing apparatus 11 through the network 12 (step S1). The receiving unit 110 outputs the printing job to the analyzing unit 120.

The analyzing unit 120 analyzes the printing job. The analyzing unit 120 writes the setting information included in the print job in the setting information memory unit 230 (step S2). The analyzing unit 120 outputs the PDL data included in the printing job to the generating unit 130. The setting information includes executing information indicating whether it is executed to estimate the count of page images that can be formed on the at least one sheet.

The generating unit 130 analyzes the PDL data outputted by the analyzing unit 120. The generating unit 130 generates the page image data set based on the PDL data (step S3).

The generating unit 130 determines whether the page image data set is completely generated (step S4).

When the page image data set is not completely generated (step S4: NO), the processing is moved to step S1. Then step S1, step S2, and Step S3 is repeated until the page image data set is completely generated.

On the other hand, when the page image data set is completely generated (step S4: YES), the generating unit 130 writes the page image data set to the printing image memory unit 200. Then the generating unit 130 outputs the completion notice to the control unit 140.

When the executing information included in the setting information stored in the setting information memory unit 230 indicates that it is executed to estimate the count of page images that can be formed on the at least one sheet, the control unit 140 commands the calculating unit 150 to calculate the required consumptions of the toners that is needed for forming image upon receipt of the completion notice.

The calculating unit 150 calculates current required consumptions of the toners based on the page image data set written in the printing image memory unit 200 newly. Then the calculating unit 150 calculates total required consumptions of the toners corresponding to a plurality of page image data sets that has already been written in the printing image memory unit 200 (step S5). The calculating unit 150 writes the current required consumptions and the total required consumptions in the consumption memory unit 210.

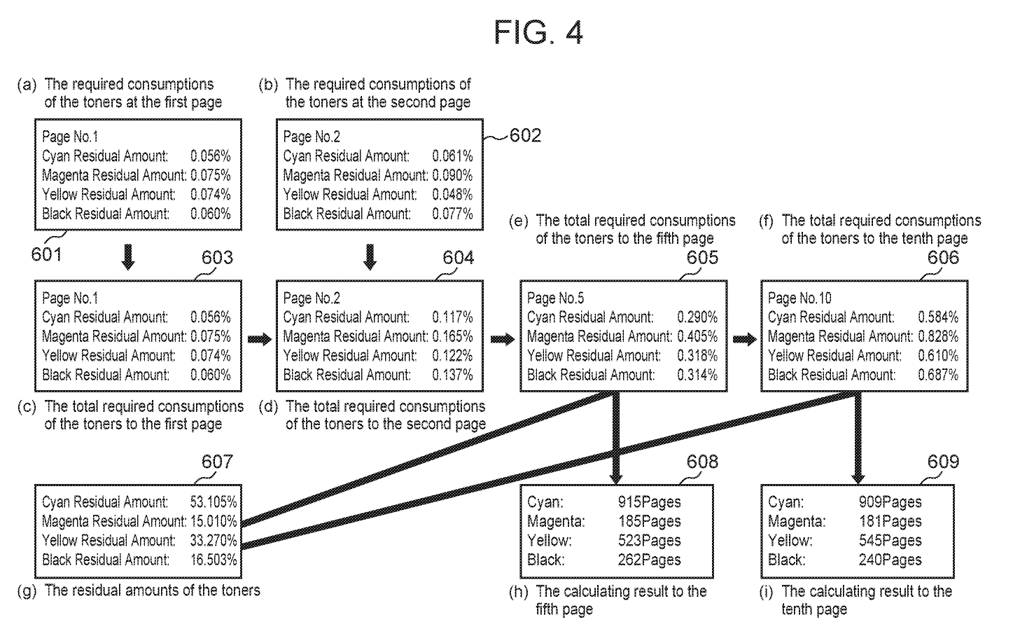

FIG. 4 is a schematic view showing a method of calculating the count of page images that can be formed on the at least one sheet. The required consumptions are expressed in percentages. An amount of toner included in a new toner cartridge is 100%. An illustration 601 indicates the current required consumptions of the toners for a first page image. An illustration 602 indicates the current required consumptions of the toners for a second page image.

An illustration 603 indicates the total required consumptions of the toners to the first page image. An illustration 604 indicates the total required consumptions of the toners to the second page image. Namely, the total required consumptions of the toners to the second page image are total value of the current required consumptions of the toner for the first page image and the second page image.

An illustration 605 indicates the total required consumptions of the toners to a fifth page image. A illustration 606 indicates the total required consumptions of the toners to a tenth page image.

As shown in FIG. 2, the control unit 140 determines whether the prescribed condition is satisfied, upon receipt of the completion notice (step S6). When the prescribed condition is satisfied (step S6: YES), the control unit 140 commands the estimating unit 160 to estimate the count of page images that can be formed on the at least one sheet. Then the processing moves to step S7. On the other hand, when the prescribed condition is not satisfied (step S6: NO), the processing moves to step S1.

The prescribed condition is a condition for estimating the count of page images that can be formed on the at least one sheet. For example, the prescribed condition may be “the every prescribed count of page images”. Specifically, the prescribed condition may be that the count of the page image data set written in the printing image memory unit 200 by the generating unit 130 reaches a predetermined threshold.

Or, for example, the prescribed condition may be “every prescribed elapsed time”. Specifically, the prescribed condition may be that the elapsed time after the generating unit 130 starts to generate the page image data set reaches a predetermined threshold. Or, the prescribed condition may be that the elapsed time after the estimating unit 160 estimates the count of the page images that can be formed on the at least one sheet reaches the predetermined threshold.

Or, for example, the prescribed condition may be “every prescribed printing distance”. Specifically, the prescribed condition may be that the printing distance reaches the predetermined threshold.

In this embodiment, the prescribed condition is “the every prescribed count of page images”. Specifically, the prescribed condition is “every five page images”. Namely, the predetermined threshold is “5”.

The estimating unit 160 calculates the count of page images that can be formed on the at least one sheet based on the total required consumptions of the toners stored in the consumption memory unit 210 and the residual amounts stored in the residual amount memory unit 220, upon receipt of a command from the control unit 140 (step S7).

The estimating unit 160 estimates the count of page images that can be formed on the at least one sheet whenever the count of the page image data sets written in the printing image memory unit 200 by the generating unit 130 reaches at least “5”, specifically, “5”, “10”, “15”, “20”, “25”.

As shown in FIG. 4, an illustration 607 indicates the residual amounts of the toners. When the count of page images reaches “5”, the estimating unit 160 calculates the count of page images that can be formed on the at least one sheet. Specifically, the estimating unit 160 divides each residual amount by the total of amount of the toner to the fifth page image. Namely, the estimating unit 160 divides 53.105% by 0.290% about the Cyan toner. The estimating unit 160 divides 15.010% by 0.405% about the Magenta toner. The estimating unit 160 divides 33.270% by 0.318% about the Yellow toner. The estimating unit 160 divides 16.503% by 0.314% about the black toner.

An illustration 608 indicates the calculating result. The estimating unit 160 calculates the count of page images about the Cyan toner as “915”. The estimating unit 160 calculates the count of page images about the Magenta as “185”. The estimating unit 160 calculates the count of page images about Yellow as “523”. The estimating unit 160 calculates the count of page images about Black as “262”.

Accordingly, the estimating unit 160 calculates each count of page images that can be formed on the at least one sheet, with respect to every toner.

As shown in FIG. 2, the estimating unit 160 commands the display unit 170 to display the calculated count of page images that can be formed on the sheet as the estimating result. The display unit 170 displays the count of page images that can be formed on the sheet (step S8). For example, the display unit 170 displays the smallest value and identification information about the toner with the smallest value among the Cyan toner, Magenta toner, Yellow toner and Black toner. In case of the illustration 608, the display unit 170 displays “185” as the count of page images, and “Magenta” as the identification information about the toner.

Next, the screen displayed by the operation panel 171 is explained.

As shown in FIG. 3A, before image forming apparatus 10 starts to execute a print processing based on the printing data, the operation panel 171 displays the message “print processing can be executed” in the LCD 172.

Next, as shown in FIG. 3B, until the prescribed condition is satisfied after image forming apparatus 10 starts to execute the print processing based on the printing data, namely until the page image data set corresponding to the fifth page is stored in the printing image memory unit 200, the operation panel 171 displays the message “it is processing” in the LCD 172.

As shown in FIG. 3C, when the prescribed condition is satisfied, namely, the page image data set corresponding to the fifth page is stored in the printing image memory unit 200, the operation panel 171 displays the smallest value of the count of page images that can be formed on the sheet and the identification information about the toner with the smallest value among the Cyan toner, Magenta toner, Yellow toner and Black toner, in the LCD 172.

The generating unit 130 determines whether a print data processing corresponding to one printing job is completed (step S9). When the print data processing corresponding to one printing job is completed (step S9: YES), the generating unit 130 outputs the completion notice to the control unit 140. Then the processing moves to step S10. On the other hand, when the printing data processing corresponding to one printing job is not completed (step S9: NO), the processing moves to step S1.

The control unit 140 outputs information for inquiring whether the toner to be required for the print job is short to the estimating unit 160. Then the estimating unit 160 compares the count of page images included in the printing job with the count of page images calculated in step S7. The estimating unit 160 determines whether the toner to be required for the print job is short. Then the control unit 140 receives information for indicating whether the toner to be required for the printing job is short from the estimating unit 160.

The control unit 140 determines whether the toner to be required for the printing job is enough based on the received information (step S10).

When the toner to be required for the printing job is short (step S10: NO), the control unit 140 commands the display unit 170 to display identification information indicating that the toner to be required for the printing job is short. Then the processing moves to step 11. On the other hand, when the toner to be required for the printing job is enough (step S10: YES), the processing moves to step S13.

The estimating unit 160 commands the display unit 170 to display the identification information indicating the toner that is short. Then the display unit 170 displays the identification information indicating the toner that is short (step S11). Specifically, the display unit 170 displays a message indicating that the Magenta toner and the Black toner are short on the LCD 172 as shown in FIG. 3F.

The OK button 173 is for starting the print processing. The Cancel button 174 is for cancelling the print processing.

The user may change the short toner. Then the user may push OK button 173. Or the user may push Cancel button 174 without changing the short toner.

When the OK button 173 is pushed (step S12: OK button), the processing moves to step S13. On the other hand, when the Cancel button 174 is pushed (step S12: Cancel button), the processing is cancelled.

When the toner to be required for the printing job is enough (step S10: YES), or when the OK button 173 is pushed (step S12: OK button), the control unit 140 commands the image forming unit 180 to form the image on the sheet. The image forming unit 180 forms the image on the continuous paper based on the printing image data corresponding to the one printing job stored in the printing image memory unit 200 (step S13). Specifically, the image forming unit 180 reads out the page image data sets sequentially. Then the image forming unit 180 forms the image corresponding to the page image data set on the continuous paper sequentially.

When the image forming unit 180 starts the printing processing, the display unit 170 displays the message “It is printing” on the LCD 172 as shown in FIG. 3E.

When the processing of step S13 is completed, the image forming unit 180 updates the residual amounts stored in the residual amount memory unit 220.

In this way, whenever the prescribed condition is satisfied, the image forming apparatus 10 estimates the required consumption of the toner. Therefore, the time for the estimate is shortened. And the convenience of the user can be improved.

Whenever the prescribed condition is satisfied, the image forming apparatus 10 displays the count of page images that can be formed on the sheet and the identification information about the toner that may be short based on the required consumption of the toners and the residual amounts of the toners. Therefore, before the print data processing corresponding to one printing job is completed, the user can determine whether the print processing should be executed. And before the print data processing corresponding to one printing job is completed, the user can change the short toner. And before the print data processing corresponding to one printing job is completed, the user can know the toner that is the smallest amount.

When the count of page images that have already generated is larger than the count of page images that can be formed on the sheet, the image forming apparatus 10 can notice the user of the fact. Specifically, in case of the illustration 609, namely, in case that the count of page images about the Cyan is “909”, the count of page images about the Magenta is “181”, the count of page images about the Yellow is “545”, and the count of page images about the Black is “240”, and in case that the count of page images that have already generated is “250”, the image forming apparatus 10 displays the message indicating that the Magenta toner and the Black toner may be short as shown in FIG. 7.

In this embodiment, the executing information is included in the printing job. Namely, the printer driver installed in information processing apparatus 11 sets the executing information. However, the image forming apparatus 10 may set the executing information based on the operation signal from the display unit 170.

The upper limit of the count of page images that can be formed on the sheet may be set in advance through the printer driver of the information processing apparatus 11 or the operation panel 171.

As shown in FIG. 3C and FIG. 3D, the predetermined upper limit is displayed in substitution for “N” of “5/N” or “10/N”.

For example, in case of the illustration 609, namely, in case that the count of page images about the Cyan is “909”, the count of page images about the Magenta is “181”, the count of page images about the Yellow is “545”, and the count of page images about the Black is “240”, and in case that the count of page images set by the user is “250”, the image forming apparatus 10 displays the message indicating that the Magenta toner and the Black toner may be short as shown in FIG. 8. In this case, the estimating unit 160 or the control unit 140 commands the display unit 170 to display the count of page images smaller than the prescribed count of page images.

In this way, the prescribed count of page images is displayed. Therefore, the convenience of the user can be improved.

### 3. Modification

Next, Modification of processing executed by the image forming apparatus 10 is explained.

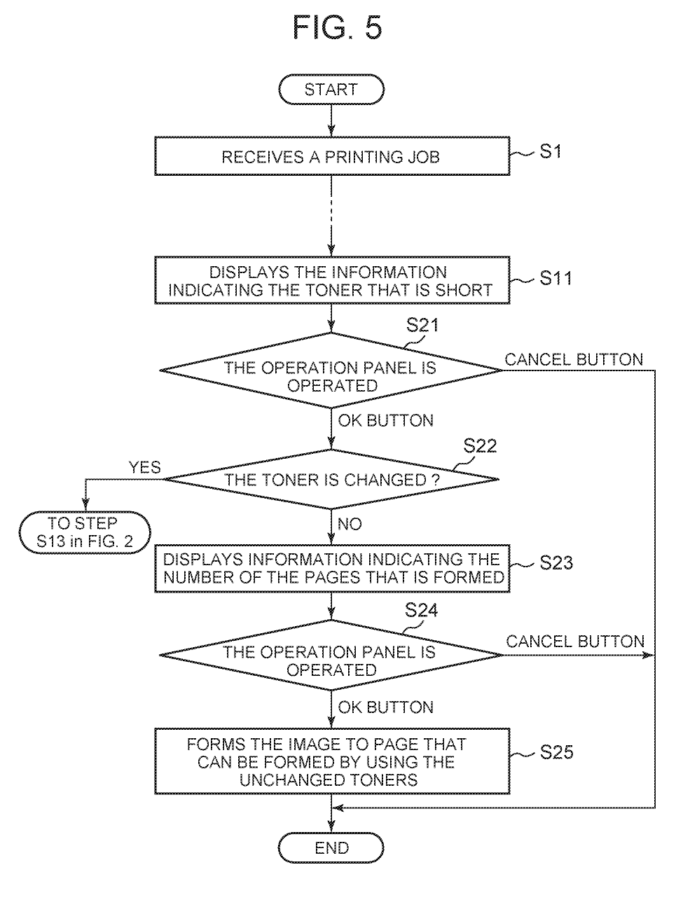

FIG. 5 is a flowchart showing processing executed by the image forming apparatus 10.

The processes from S1 to S11 are done in the same way as the processes from S1 to S11 shown in FIG. 4. Therefore these explanations are omitted.

When the control unit 140 receives an operation signal for starting the print processing from the display unit 170 (step S21: OK BUTTON), the processing moves to step S22. On the other hand, when the control unit 140 receives an operation signal for cancelling the print processing from the display unit 170 (step S21: CANCEL BUTTON), the control unit 140 cancels the print processing.

While the display unit 170 displays the identification information indicating the toner that is short, the user may change the toner that is short.

If the OK Button 173 is pushed (step S21: OK BUTTON), the control unit 140 determines whether the toner that is short is changed (step S22).

If the toner that is short is changed (step S22: YES), the processing moves to step S13 shown in FIG. 2.

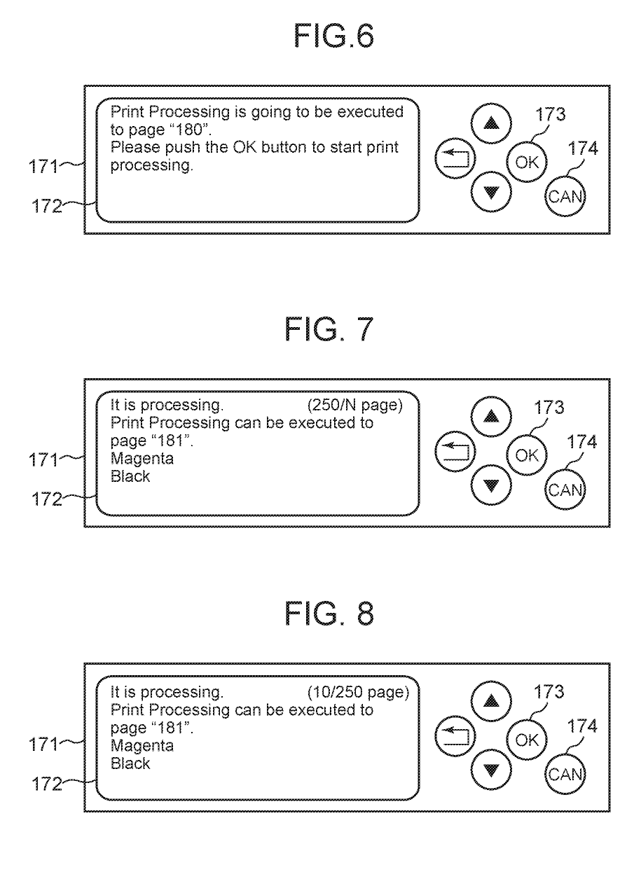

On the other hand, if the toner that is short is not changed (step S22: NO), the control unit 140 commands the display unit 170 to display information indicating the count of page images that is formed. The display unit 170 displays the information indicating the count of page images that is formed (step S23). Specifically, the display unit 170 displays the message “The print processing is executed to 180 page. Please push the OK button to start print processing” in the LCD 172 shown in FIG. 6.

The count of page images displayed on the LCD 172 is the count of the page images can be formed on the sheet based on the toners without changing. For example, in the illustration 608, the smallest value is “185”. The count of page images displayed on the LCD 172 is calculated based on the predetermined threshold.

If the predetermined threshold is “5”, “185” is displayed on the LCD 172. If the predetermined threshold is “10”, “180” is displayed on the LCD 172.

As shown in FIG. 6, the Cancel button 174 is pushed by the user (step S24: CANCEL BUTTON), the control unit 140 cancels the print processing.

On the other hand, the OK button 172 is pushed by the user (step S24: OK BUTTON), the control unit 140 commands the image forming unit 180 to form the image to page that can be formed by using the unchanged toners. Then the image forming unit 180 forms the image to page that can be formed by using the unchanged toners based on the page image data sets stored in the printing image memory unit 200 (step S25).

When the image forming unit 180 starts the printing processing, the display unit 170 displays the message “It is printing” on the LCD 172 as shown in FIG. 3E.

When the processing of step S25 is completed, the image forming unit 180 updates the residual amounts stored in the residual amount memory unit 220. Then the processing is completed.

In this way, even if the toner is short, the print processing is executed to the page that can be formed by selection of the user.

The information processing apparatus 11 may include the calculating unit 150 and the estimating unit 160. In this case, the information processing apparatus 11 may receive information about the residual amount of the toners from the image processing apparatus 10.

The image forming apparatus may be a multifunction machine, a printer, a copy apparatus or a FAX apparatus.

The present invention is not limited to the foregoing embodiment but many modifications and variations are possible within the spirit and scope of the appended claims of the invention.

What is claimed is:

1. An image forming apparatus comprising:
a receiving unit that receives image data sequentially;
an image forming unit that forms at least one page image on at least one sheet based on the image data;
a detecting unit that detects a residual amount of a consumable used for forming the page image by the image forming unit;
a first calculating unit that calculates a consumption of the consumable based on the image data received by a time point by the receiving unit whenever a prescribed condition is satisfied;
a second calculating unit that calculates a count of page images that can be formed on the at least one sheet based on the consumption and the residual amount whenever the prescribed condition is satisfied; and
a display unit that displays the count of page images calculated by the second calculating unit whenever the prescribed condition is satisfied.

2. The image forming apparatus according to claim 1, wherein the prescribed condition is that the count of page images corresponding to the image data received by the receiving unit reaches a threshold.

3. The image forming apparatus according to claim 1, wherein the prescribed condition is a prescribed time period.

4. The image forming apparatus according to claim 1, wherein the detecting unit detects residual amounts of at least two consumables;
wherein the first calculating unit separately calculates consumption of each consumable;
wherein the second calculating unit calculates a count of page images corresponding to each consumable based on the consumption of each consumable and their respective residual amount.

5. The image forming apparatus according to claim 4, wherein the second calculating unit commands the display unit to display the smallest count of page images in each count of page images.

6. The image forming apparatus according to claim 5, wherein the second calculating unit commands the display unit to display identification information about the consumable corresponding to the smallest count of page images.

7. The image forming apparatus according to claim 1, wherein the second calculating unit commands the display unit to display the count of page images smaller than the prescribed count of page images.

8. The image forming apparatus according to claim 1, wherein the image forming unit forms at least one page image corresponding to the count of page images smaller than the count of page images calculated by the second calculating unit.

9. The image forming apparatus according to claim 1, wherein the sheet is a continuous paper.

10. The image forming apparatus according to claim 1, wherein the consumable is a developer.

11. The information processing apparatus comprising:
a receiving unit that receives image data sequentially;
a detecting unit that detects a residual amount of a consumable used for forming a page image;
a first calculating unit that calculates a consumption of the consumable based on the image data received by a time point by the receiving unit whenever a prescribed condition is satisfied;
a second calculating unit that calculates a count of page images that can be formed on at least one sheet based on the consumption and the residual amount whenever the prescribed condition is satisfied; and
an output unit that outputs the count of page images calculated by the second calculating unit whenever the prescribed condition is satisfied.
